(19) United States
(12) Patent Application Publication
(10) Pub. No.: US 2013/0172501 A1
(43) Pub. Date: Jul. 4, 2013

(54) POLYMER FOR OPTICAL FILM, METHOD OF PREPARING SAME, AND OPTICAL FILM INCLUDING SAME

(71) Applicants: Won Cheol JUNG, Seoul (KR); Moon Yeon LEE, Osan-si (KR); Kyu Yeol IN, Seoul (KR); Woo Joong KIM, Uiwang-si (KR); Hyung Jun KIM, Suwon-si (KR); Hyeon Ho CHOI, Seoul (KR); Jong-Hoon WON, Yongin-si (KR); Myung Sup JUNG, Seongnam-si (KR)

(72) Inventors: Won Cheol JUNG, Seoul (KR); Moon Yeon LEE, Osan-si (KR); Kyu Yeol IN, Seoul (KR); Woo Joong KIM, Uiwang-si (KR); Hyung Jun KIM, Suwon-si (KR); Hyeon Ho CHOI, Seoul (KR); Jong-Hoon WON, Yongin-si (KR); Myung Sup JUNG, Seongnam-si (KR)

(73) Assignees: CHEIL INDUSTRIES, INC., Kumi-city (KR); SAMSUNG ELECTRONICS CO., LTD., Suwon-si (KR)

(21) Appl. No.: 13/560,681

(22) Filed: Jul. 27, 2012

(30) Foreign Application Priority Data
Dec. 28, 2011 (KR) 10-2011-0144747

(51) Int. Cl. C08F 212/10

(52) U.S. Cl. 526/232.3; 526/299; 526/298

(57) ABSTRACT

A polymer for an optical film that includes a repeating unit A including a repeating unit represented by the following Chemical Formula 1; and a repeating unit B including a repeating unit represented by the following Chemical Formula 2,

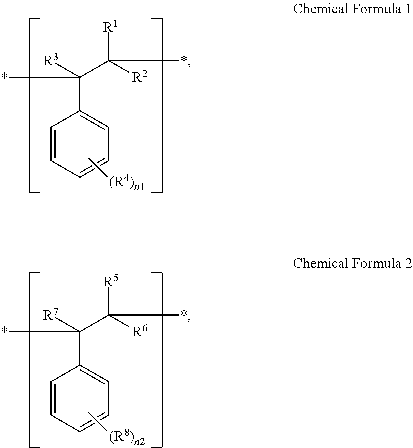

wherein R¹ to R⁸, n1 and n2, are defined herein.

### CROSS-REFERENCE TO RELATED APPLICATION

This application claims priority to Korean Patent Application No. 10-2011-0144747, filed on Dec. 28, 2011, and all the benefits accruing therefrom under 35 U.S.C. §119, the entire content of which is incorporated herein by reference.

### BACKGROUND

1. Field

This disclosure relates to a polymer for an optical film, a method of preparing the same, an optical film including the same, and a display device including the optical film.

2. Description of the Related Art

A reverse wavelength dispersion phase-difference compensation film has been used to compensate a phase difference and improve wide viewing angle and a color shift in a display device such as a liquid crystal display (“LCD”), an organic light emitting diode (“OLED”) device, and the like. However, a display device such as a liquid crystal display, an organic light emitting diode device, and the like is fabricated using a method including a high temperature process. Accordingly, development of a material having excellent heat resistance for use in an optical film, including a reverse wavelength dispersion phase-difference compensation film, is desired.

### SUMMARY

An embodiment provides a polymer for an optical film having excellent or improved negative birefringence, heat resistance, and moisture resistance.

Another embodiment provides a method of preparing the polymer for an optical film.

Another embodiment provides an optical film including the polymer for an optical film.

Another embodiment provides a display device including the optical film.

According to an embodiment, provided is a polymer for an optical film that includes a repeating unit A including a repeating unit represented by the following Chemical Formula 1; and a repeating unit B including a repeating unit represented by the following Chemical Formula 2.

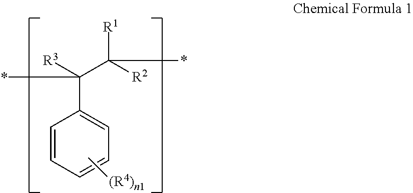

In Chemical Formula 1,

R¹ and R² are the same or different in each repeating unit and are each independently hydrogen, a substituted or unsubstituted C1 to C10 aliphatic group, —CN, or —C(═O)OR²⁰⁰, wherein R²⁰⁰ is a substituted or unsubstituted C1 to C30 aliphatic group, a substituted or unsubstituted C3 to C30 alicyclic group, a substituted or unsubstituted C6 to C30 aromatic group, or a substituted or unsubstituted C2 to C30 heterocyclic group, wherein at least one of R¹ and R² is —CN or —C(═O)OR²⁰⁰. In an embodiment, R¹ and R² are the same or different in each repeating unit and are each independently —CN or —C(═O)OR²⁰⁰, wherein R²⁰⁰ is a C1 to C20 alkyl group, a C6 to C20 aryl group, a C7 to C20 arylalkyl group, or a C7 to C20 alkylaryl group.

R³ is the same or different in each repeating unit and each is independently hydrogen, a substituted or unsubstituted C1 to C10 aliphatic group, —CN, or —C(═O)OR²⁰¹, wherein R²⁰¹ is a substituted or unsubstituted C1 to C30 aliphatic group, a substituted or unsubstituted C3 to C30 alicyclic organic group, a substituted or unsubstituted C6 to C30 aromatic organic group, or a substituted or unsubstituted C2 to C30 heterocyclic group. In an embodiment, R³ is the same or different in each repeating unit and each is independently hydrogen, or a substituted or unsubstituted C1 to C10 alkyl group.

R⁴ is the same or different in each repeating unit and each is independently a halogen, a substituted or unsubstituted C1 to C30 aliphatic group, a substituted or unsubstituted C3 to C30 alicyclic group, a substituted or unsubstituted C6 to C30 aromatic group, a substituted or unsubstituted C2 to C30 heterocyclic group, a substituted or unsubstituted C1 to C30 alkoxy group, a substituted or unsubstituted C6 to C30 aryloxy group, a substituted or unsubstituted C2 to C30 ester group (—OC(═O)R²⁰² or —C(═O)OR²⁰³, wherein R²⁰² and R²⁰³ are the same or different and are each independently a C1 to C10 alkyl group), a substituted or unsubstituted C2 to C30 ketone group, a carboxyl group, a cyano group, or —N(R²⁰⁴)(R²⁰⁵), (wherein R²⁰⁴ and R²⁰⁵ are the same or different and are each independently hydrogen, or a substituted or unsubstituted C1 to C10 aliphatic group), wherein the alicyclic group, aromatic group, and heterocyclic group are present singularly; at least two of the alicyclic group, aromatic group, and heterocyclic group are linked to provide a condensed cyclic group; or at least two of the alicyclic group, aromatic group, and heterocyclic group are linked via a single bond, —O—, —S—, —C(═O)—, —CH(OH)—, —S(═O)₂—, —Si(CH₃)₂—, —(CH₂)ₚ— (wherein 1≦p≦10), —(CF₂)_{q}— (wherein 1≦q≦10), —C(CH₃)₂—, —C(CF₃)₂—, or —C(═O)NH—. In an embodiment, R⁴ is the same or different in each repeating unit and each is independently hydrogen, a halogen, a substituted or unsubstituted C1 to C10 alkoxy group, a substituted or unsubstituted C6 to C15 aryloxy group, a substituted or unsubstituted C2 to C10 ester group (—OC(═O)R²⁰² or —C(═O)OR²⁰³, wherein R²⁰² and R²⁰³ are the same or different and are each independently a C1 to C10 alkyl group), or a carboxyl group.

n1 is the same or different in each repeating unit and each is independently an integer ranging from 0 to 5.

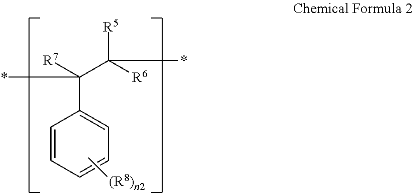

In Chemical Formula 2,

R⁵ to R⁷ are the same or different in each repeating unit and are each independently hydrogen, or a substituted or unsubstituted C1 to C10 aliphatic group. In an embodiment, R⁵ to R⁷ are the same or different in each repeating unit and are each independently hydrogen, or a substituted or unsubstituted C1 to C10 alkyl group.

R⁸ is the same or different in each repeating unit and each is independently a halogen, a substituted or unsubstituted C1 to C30 aliphatic group, a substituted or unsubstituted C3 to C30 alicyclic group, a substituted or unsubstituted C6 to C30 aromatic group, a substituted or unsubstituted C2 to C30 heterocyclic group, a substituted or unsubstituted C1 to C30 alkoxy group, a substituted or unsubstituted C6 to C30 aryloxy group, a substituted or unsubstituted C2 to C30 ester group (—OC(═O)R²⁰⁶ or —C(═O)OR²⁰⁷, wherein R²⁰⁶ and R²⁰⁷ are the same or different and are each independently a C1 to C10 alkyl group), a substituted or unsubstituted C2 to C30 ketone group, a carboxyl group, a cyano group, or —N(R²⁰⁸)(R²⁰⁹) (wherein R²⁰⁸ and R²⁰⁹ are the same or different and are each independently hydrogen, or a substituted or unsubstituted C1 to C10 aliphatic group), wherein the alicyclic group, aromatic group, and heterocyclic group are present singularly; at least two of the alicyclic group, aromatic group, and heterocyclic group are linked to provide a condensed cyclic group; or at least two of the alicyclic group, aromatic group, and heterocyclic group are linked via a single bond, —O—, —S—, —C(═O)—, —CH(OH)—, —S(═O)₂—, —Si(CH₃)₂—, —(CH₂)ₚ— (wherein 1≦p≦10), —C(CF₃)₂— (wherein 1≦q≦10), —C(CH₃)₂—, —C(CF₃)₂—, or —C(═O)NH—.

In an embodiment, R⁸ is the same or different in each repeating unit and each is independently a halogen, a substituted or unsubstituted C1 to C10 alkoxy group, a substituted or unsubstituted C6 to C15 aryloxy group, a substituted or unsubstituted C2 to C10 ester group (−OC(═O)R²⁰⁶ or —C(═O)OR²⁰⁷, wherein R²⁰⁶ and R²⁰⁷ are the same or different and are each independently a C1 to C10 alkyl group), or a carboxyl group.

n2 is the same or different in each repeating unit and each is independently an integer ranging from 0 to 5.

In an embodiment, the repeating unit represented by the Chemical Formula 1 may include a repeating unit represented by the following Chemical Formulas 3 to 5, or a combination thereof, and the repeating unit represented by the Chemical Formula 2 may include a repeating unit represented by the following Chemical Formulas 6 to 9, or a combination thereof.

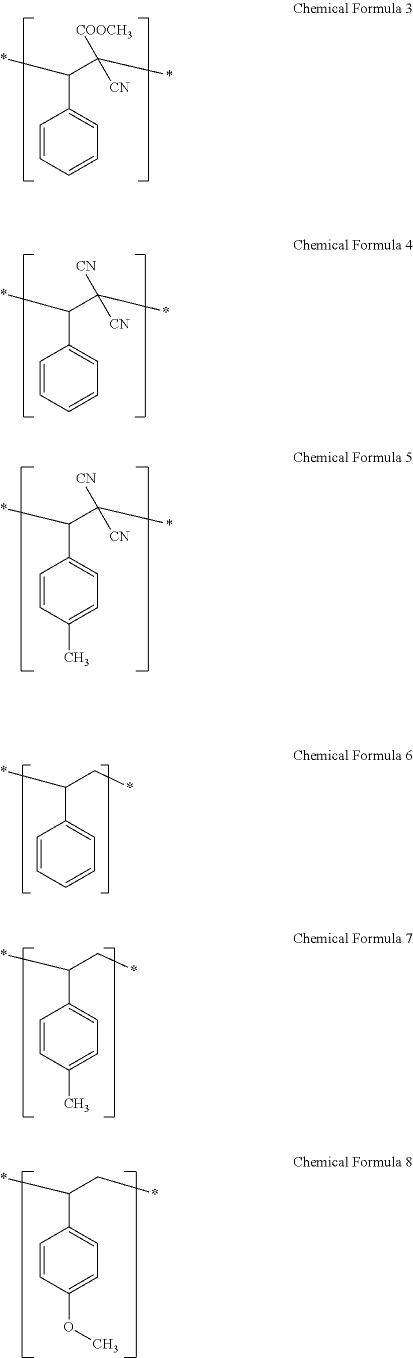

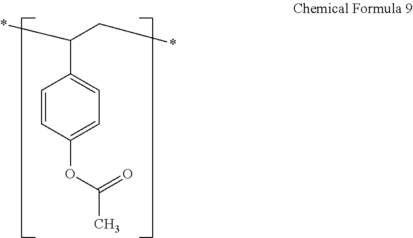

The polymer for an optical film may include the repeating unit A in an amount of greater than 0 mol % and less than or equal to about 50 mol %, and the repeating unit B in an amount of greater than or equal to about 50 mol % and less than 100 mol %, based on a total moles of the repeating units included in the polymer for an optical film.

The polymer for an optical film may have a weight average molecular weight (“Mw”) of about 100,000 grams per mole (g/mol) to about 1,000,000 g/mol, a number average molecular weight (“Mn”) of about 50,000 g/mol to about 500,000 g/mol, and a polydispersity index of and about 1.1 to about 5.0.

The polymer for an optical film may have a refractive index of about 1.50 to about 1.65.

The polymer for an optical film may have a glass transition temperature (“T_{g}”) of about 80° C. to about 200° C.

According to another embodiment, provided is a method of preparing a polymer for an optical film that includes contacting a monomer represented by the following Chemical Formula 1-1, a monomer represented by the following Chemical Formula 2-1, and a free radical initiator, and polymerizing the monomers to provide the polymer for the optical film.

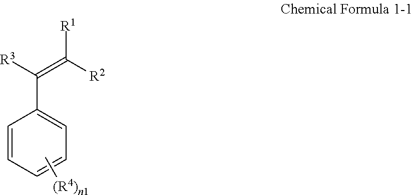

In Chemical Formula 1-1,

R¹, R², R³, R⁴, and n1 are the same as defined in Chemical Formula 1.

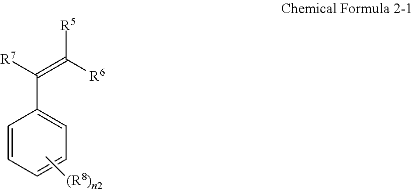

In Chemical Formula 2-1,

R⁵ to R⁸, and n2 are the same as defined in Chemical Formula 2.

The free radical initiator may include a peroxide-containing initiator, an azo-containing initiator, or a combination thereof. The peroxide-containing initiator may include benzoyl peroxide, t-butylperoxy-2-ethyl hexanoate, dicumyl peroxide, t-butyl peroxide, 1,1-di(t-butylperoxy)cyclohexane, dibenzoyl peroxide, 2-butanone peroxide, t-butyl perbenzoate, 2,5-bis(t-butylperoxy)-2,5-dimethylhexane, bis(t-butylperoxyisopropyl)benzene, t-butyl hydroperoxide, or a combination thereof.

According to yet another embodiment, an optical film including the polymer for an optical film is provided.

The optical film may have an in-plane phase-difference value (“Rₑ”) ranging from about 0 nanometers (nm) to about 500 nm at a wavelength of about 550 nm, and a thickness direction phase-difference value (“Rₜₕ”) ranging from about 0 nm to about −1000 nm at a wavelength of about 550 nm.

The optical film may have a short wavelength dispersion of an in-plane phase-difference value (“Rₑ”) (450 nm/550 nm) ranging from about 1.00 to about 1.20, and a long wavelength dispersion of an in-plane phase-difference value (“Rₑ”) (650 nm/550 nm) ranging from about 0.90 to about 1.00.

The optical film may have an average light transmittance of greater than or equal to about 80% at a wavelength range of about 380 nm to about 780 nm.

The optical film may have a haze of less than or equal to about 5%.

The optical film may have a glass transition temperature (“T_{g}”) of about 80° C. to about 200° C.

According to still another embodiment, a display device including the optical film is provided.

### BRIEF DESCRIPTION OF THE DRAWING

The above and other aspects, advantages and features of this disclosure will become more apparent by describing in further detail embodiments thereof with reference to the accompanying drawings.

FIG. 1 is a cross-sectional view showing a liquid crystal display (“LCD”) according to an embodiment, as disclosed herein.

### DETAILED DESCRIPTION

This disclosure will be described more fully hereinafter with reference to the accompanying drawings, in which various embodiments are shown. This disclosure may, however, be embodied in many different forms and should not be construed as limited to the exemplary embodiments set forth herein.

Rather, these embodiments are provided so that this disclosure will be thorough and complete, and will fully convey the scope of the invention to those skilled in the art. Like reference numerals refer to like elements throughout.

In the drawings, the thickness of layers, films, panels, regions, etc., are not to scale for clarity.

It will be understood that when an element such as a layer, film, region, or substrate is referred to as being “on” or “disposed on” another element, it can be directly on the other element or intervening elements may also be present. In contrast, when an element is referred to as being “directly on” or “directly disposed on” another element, there are no intervening elements present.

The terminology used herein is for the purpose of describing particular embodiments only and is not intended to be limiting. As used herein, the singular forms “a,” “an,” and “the” are intended to include the plural forms as well, including “at least one,” unless the content clearly indicates otherwise. “Or” means “and/or.” It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning consistent with their meaning in the context of the relevant art and the present disclosure, and will not be interpreted in an idealized or overly formal sense unless expressly so defined herein.

As used herein, when a specific definition is not otherwise provided, the term “substituted” refers to a compound or group substituted with a substituent including a halogen (specifically the halogens —F, —Cl, —Br, or —I), a hydroxyl group, a nitro group, a cyano group, an amino group (—NH₂, —NH(R¹⁰⁰) or —N(R¹⁰¹)(R¹⁰²) wherein R¹⁰⁰, R¹⁰¹, and R¹⁰² are the same or different, and are each independently a C1 to C10 alkyl group), an amidino group, a hydrazino group, a hydrazono group, a carboxyl group, an ester group, a ketone group, a substituted or unsubstituted C1 to C30 alkyl group, a substituted or unsubstituted C3 to C30 alicyclic group, a substituted or unsubstituted C6 to C30 aryl group, a substituted or unsubstituted C2 to C30 alkenyl group, a substituted or unsubstituted C2 to C30 alkynyl group, a substituted or unsubstituted C5 to C30 heteroaryl group, and a substituted or unsubstituted C2 to C30 heterocyclic group instead of hydrogen of a functional group, or two or more of the forgoing substituents are linked to each other to provide a ring, provided that the substituted atom's normal valence is not exceeded.

As used herein, when a specific definition is not otherwise provided, the term “alkyl” group refers to a straight or branched chain saturated aliphatic hydrocarbon having the specified number of carbon atoms, for example a C1 to C30 alkyl group, and specifically a C1 to C15 alkyl group, and having a valence of at least one, optionally substituted with one or more substituents where indicated, provided that the valence of the alkyl group is not exceeded.

The term “alkylaryl” group refers to an alkyl group as defined herein, substituted with an aryl group as defined herein.

The term “cycloalkyl” group refers to a group that comprises one or more saturated and/or partially saturated rings in which all ring members are carbon, such as cyclopropyl, cyclobutyl, cyclopentyl, cyclohexyl, cycloheptyl, cyclooctyl, adamantyl and partially saturated variants of the foregoing, such as cycloalkenyl groups (e.g., cyclohexenyl) or cycloalkynyl groups, and having a valence of at least one, and optionally substituted with one or more substituents where indicated, provided that the valence of the alkyl group is not exceeded. Cycloalkyl groups do not include an aromatic ring or a heterocyclic ring. When the numbers of carbon atoms is specified, for example a C3 to C30 cycloalkyl group, and specifically a C3 to C18 cycloalkyl group, wherein the number means the number of ring members present in the one or more rings.

The term “cycloalkenyl” group refers to a stable monovalent aliphatic monocyclic or polycyclic group having at least one carbon-carbon double bond, wherein all ring members are carbon. Non-limiting examples include cyclopentenyl and cyclohexenyl.

The term “cycloalkynyl” group refers to a stable aliphatic monocyclic or polycyclic group having at least one carbon-carbon triple bond, wherein all ring members are carbon. Non-limiting examples include cyclohexynyl.

The term “cycloalkylene” group refers to a divalent radical formed by the removal of two hydrogen atoms from one or more rings of a cycloalkyl group, as defined above.

The term “cycloalkenylene” group refers to a stable aliphatic 5-15-membered monocyclic or polycyclic, divalent radical having at least one carbon-carbon double bond, which comprises one or more rings connected or bridged together. Unless mentioned otherwise, the cycloalkenylene radical can be linked at any desired carbon atom provided that a stable structure is obtained. If the cycloalkenylene radical is substituted, this may be so at any desired carbon atom, once again provided that a stable structure is obtained. Non-limiting examples thereof include cyclopentenylene, cyclohexenylene, cycloheptenylene, cyclooctenylene, cyclononenylene, cyclodecenylene, norbornenylene, 2-methylcyclopentenylene, 2-methylcyclooctenylene, and the like.

The term “cycloalkynylene” group refers to a stable aliphatic 8- to 15-membered monocyclic or polycyclic divalent radical having at least one carbon-carbon triple bond and consisting solely of carbon and hydrogen atoms which may comprise one or more fused or bridged ring(s), preferably a 8- to 10-membered monocyclic or 12- to 15-membered bicyclic ring. Unless otherwise specified, the cycloalkynylene ring may be attached at any carbon atom which results in a stable structure and, if substituted, may be substituted at any suitable carbon atom which results in a stable structure. Non-limiting examples include cyclooctynylene, cyclononynylene, cyclodecynylene, 2-methylcyclooctynylene, and the like.

The term “alkoxy” group refers to an alkyl group as defined above, having the specified number of carbon atoms, for example a C1 to C30 alkoxy group, and specifically a C1 to C18 alkoxy group, linked via an oxygen, e.g. alkyl-O—.

The term “ester” group refers to a —C(═O)OR group, or —OC(═O)R group wherein R is an aliphatic group as defined below, having the specified number of carbon atoms, for example a C2 to C30 ester group, and specifically a C2 to C18 ester group, wherein the carbon of the carbonyl group is included in the specified number of carbon atoms.

The term “ketone” group refers to a —C(═O)R group, wherein R is an aliphatic group as defined below, having the specified number of carbon atoms, for example a C2 to C30 ketone group, and specifically a C2 to C18 ketone group, wherein the carbon of the carbonyl group is included in the specified number of carbon atoms.

The term “aryl” group refers to a cyclic group in which all ring members are carbon and at least one ring is aromatic, the group having the specified number of carbon atoms, for example a C6 to C30 aryl group, and specifically a C6 to C18 aryl group, and having a valence of at least one, optionally substituted with one or more substituents where indicated, provided that the valence of the aryl group is not exceeded. More than one ring may be present, and any additional rings may be independently aromatic, saturated or partially unsaturated, and may be fused, pendant, spirocyclic, or a combination thereof.

The term “aryloxy” group refers to an aryl group as defined above, having the specified number of carbon atoms, for example a C6 to C30 aryloxy group, and specifically a C6 to C18 aryloxy group, linked via an oxygen, e.g. aryl-O—.

The term “arylalkyl” group refers to an aryl group as defined herein, substituted with an alkyl group as defined herein.

The term “alkenyl” group refers to a straight or branched chain hydrocarbon that comprises at least one carbon-carbon double bond, having the specified number of carbon atoms, for example a C2 to C30 alkenyl group, and specifically a C2 to C18 alkenyl group, and having a valence of at least one, optionally substituted with one or more substituents where indicated, provided that the valence of the alkenyl group is not exceeded.

The term “alkynyl” group refers to a straight or branched chain, monovalent hydrocarbon group having at least one carbon-carbon triple bond. Non-limiting examples include ethynyl.

The term “alkylene” group refers to a straight or branched chain, saturated, aliphatic hydrocarbon group having the specified number of carbon atoms, for example a C1 to C30 alkylene group, and specifically a C1 to C18 alkylene group, and having a valence of at least two, optionally substituted with one or more substituents where indicated, provided that the valence of the alkyl group is not exceeded.

The term “alkeneylene” group refers to a straight or branched chain hydrocarbon group having at least one carbon-carbon double bond and having a valence of at least two, optionally substituted with one or more substituents where indicated, provided that the valence of the alkyl group is not exceeded.

The term “alkynylene” group refers to a straight or branched chain divalent aliphatic hydrocarbon that has one or more unsaturated carbon-carbon bonds, at least one of which is a triple bond. Non-limiting examples include ethynylene.

The term “arylene” group refers to a divalent radical formed by the removal of two hydrogen atoms from one or more rings of an aromatic hydrocarbon, wherein the hydrogen atoms may be removed from the same or different rings, each of which rings may be aromatic or nonaromatic, and having the specified number of carbon atoms, for example a C6 to C30 arylene group, and specifically a C6 to C16 arylene group.

As used herein, when a specific definition is not otherwise provided, the term “aliphatic group” refers to a C1 to C30 alkyl group, a C2 to C30 alkenyl group, a C2 to C30 alkynyl group, a C1 to C30 alkylene group, a C2 to C30 alkenylene group, or a C2 to C30 alkynylene group, and specifically a C1 to C15 alkyl group, a C2 to C15 alkenyl group, a C2 to C15 alkynyl group, a C1 to C15 alkylene group, a C2 to C15 alkenylene group, or C2 to C15 alkynylene group.

The term “alicyclic group” refers to a C3 to C30 cycloalkyl group, a C3 to C30 cycloalkenyl group, a C3 to C30 cycloalkynyl group, a C3 to C30 cycloalkylene group, a C3 to C30 cycloalkenylene group, or C3 to C30 cycloalkynylene group, and specifically a C3 to C15 cycloalkyl group, a C3 to C15 cycloalkenyl group, a C3 to C15 cycloalkynyl group, a C3 to C15 cycloalkylene group, a C3 to C15 cycloalkenylene group, or C3 to C15 cycloalkynylene group.

The term “aromatic group” refers to a C6 to C30 aryl group or C6 to C30 arylene group, and specifically a C6 to C16 aryl group or C6 to C16 arylene group.

The term “heterocyclic group” refers to a C2 to C30 heterocycloalkyl group, a C2 to C30 heterocycloalkylene group, a C2 to C30 heterocycloalkenyl group, a C2 to C30 heterocycloalkenylene group, a C2 to C30 heterocycloalkynyl group, a C2 to C30 heterocycloalkynylene group, a C2 to C30 heteroaryl group, or C2 to C30 heteroarylene group that include 1 to 3 heteroatoms selected from O, S, N, P, Si, and a combination thereof in one ring, and specifically a C2 to C15 heterocycloalkyl group, a C2 to C15 heterocycloalkylene group, a C2 to C15 heterocycloalkenyl group, a C2 to C15 heterocycloalkenylene group, a C2 to C15 heterocycloalkynyl group, a C2 to C15 heterocycloalkynylene group, a C2 to C15 heteroaryl group, or a C2 to C15 heteroarylene group, wherein the foregoing heterocyclic groups each include 1 to 3 heteroatoms selected from O, S, N, P, Si, and a combination thereof in one ring. Other heteroatoms may also be present.

A “heteroalkyl” group is an alkyl group as defined above, that comprises at least one heteroatom covalently bonded to one or more carbon atoms of the alkyl group. Each heteroatom is independently chosen from N, O, S, Si, or P.

A “heteroaralkyl” group refers to an alkyl group as defined above in which one of the hydrogen atoms of the alkyl is replaced by a heteroaryl group.

A “heteroaryl” group refers to a monovalent carbocyclic ring group that includes one or more aromatic rings, in which at least one ring member (e.g., one, two or three ring members) is a heteroatom. In a C3 to C30 heteroaryl, the total number of ring carbon atoms ranges from 3 to 30, with remaining ring atoms being heteroatoms. Multiple rings, if present, may be pendent, spiro or fused. The heteroatom(s) are independently chosen from N, O, S, Si, or P.

A “heteroarylalkyl” group refers to a heteroaryl group as defined above, linked via an alkylene moiety, as defined above. The specified number of carbon atoms (e.g., C3 to C30) means the total number of carbon atoms present in both the aryl and the alkylene moieties, with remaining ring atoms being heteroatoms as defined above.

A “heteroarylene” group refers to a divalent radical formed by the removal of two hydrogen atoms from one or more rings of a heteroaryl moiety, as defined above, wherein the hydrogen atoms may be removed from the same or different rings (preferably the same ring), each of which rings may be aromatic or nonaromatic.

The term “condensed cyclic group” refers to a group having two or more rings, wherein at least two of the rings are fused, i.e., share at least two carbon atoms.

As used herein, when a definition is not otherwise provided, “combination” commonly refers to a mixture or copolymer, a stacked structure, a composite, an alloy, a blend, a reaction product, or the like.

The term “combination thereof” refers to a combination comprising at least one of the named constituents, components, compounds, or elements, optionally together with one or more of the same class of constituents, components, compounds, or elements not named.

The term “copolymerization” includes random copolymerization, block copolymerization, or graft copolymerization, and the like, and the terms “polymer” and “copolymer” include a random copolymer, block copolymer, or graft copolymer, and the like.

In addition, in the specification, the mark “*” refers to a point of attachment to a repeating unit.

The term “(meth)acrylate” refers to an acrylate group (H₂C═CH—C(═O)O—) and a methacrylate group (H₂C═C(CH₃)—C(═O)—), and (meth)acryloxy refers to an acryloxy group and a methacryloxy group.

According to an embodiment, provided is a polymer for an optical film that includes a repeating unit A including a repeating unit represented by the following Chemical Formula 1; and a repeating unit B including a repeating unit represented by the following Chemical Formula 2. In an embodiment, the polymer for an optical film may be a random copolymer, but is not limited thereto, and may include a block copolymer, a graft copolymer, and the like.

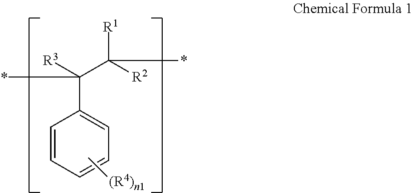

In Chemical Formula 1,

R¹ and R² are the same or different in each repeating unit and are each independently hydrogen, a substituted or unsubstituted C1 to C10 aliphatic group, —CN, or —C(═O)OR²⁰⁰, wherein R²⁰⁰ is a substituted or unsubstituted C1 to C30 aliphatic group, a substituted or unsubstituted C3 to C30 alicyclic group, a substituted or unsubstituted C6 to C30 aromatic group, or a substituted or unsubstituted C2 to C30 heterocyclic group, wherein at least one of R¹ and R² is —CN or —C(═O)OR²⁰⁰. In an embodiment, R¹ and R² are the same or different in each repeating unit and are each independently —CN, or —C(═O)OR²⁰⁰, wherein R²⁰⁰ is a C1 to C20 alkyl group, a C6 to C20 aryl group, a C7 to C20 arylalkyl group, or a C7 to C20 alkylaryl group. In another embodiment, R²⁰⁰ may be a C1 to C10 alkyl group.

R³ is the same or different in each repeating unit and each is independently hydrogen, a substituted or unsubstituted C1 to C10 aliphatic group, —CN or —C(═O)OR²⁰¹, wherein R²⁰¹ is a substituted or unsubstituted C1 to C30 aliphatic group, a substituted or unsubstituted C3 to C30 alicyclic group, a substituted or unsubstituted C6 to C30 aromatic group, or a substituted or unsubstituted C2 to C30 heterocyclic group. In an embodiment, R³ is the same or different in each repeating unit and each is independently hydrogen, or a substituted or unsubstituted C1 to C10 alkyl group, and in another embodiment, R³ is hydrogen.

R⁴ is the same or different in each repeating unit and each is independently a halogen, a substituted or unsubstituted C1 to C30 aliphatic group, a substituted or unsubstituted C3 to C30 alicyclic group, a substituted or unsubstituted C6 to C30 aromatic group, a substituted or unsubstituted C2 to C30 heterocyclic group, a substituted or unsubstituted C1 to C30 alkoxy group, a substituted or unsubstituted C6 to C30 aryloxy group, a substituted or unsubstituted C2 to C30 ester group (—OC(═O)R²⁰² or —C(═O)OR²⁰³, wherein R²⁰² and R²⁰³ are the same or different and are each independently a C1 to C10 alkyl group), a substituted or unsubstituted C2 to C30 ketone group, a carboxyl group, a cyano group, or —N(R²⁰⁴)(R²⁰⁵), (wherein R²⁰⁴ and R²⁰⁵ are the same or different and are each independently hydrogen, or a substituted or unsubstituted C1 to C10 aliphatic group), wherein the alicyclic group, aromatic group, and heterocyclic group are present singularly; at least two of the alicyclic group, aromatic group, and heterocyclic group are linked to provide a condensed cyclic group; or at least two of the alicyclic group, aromatic group, and heterocyclic group are linked via a single bond, —O—, —S—, —C(═O)—, —CH(OH)—, —S(═O)₂—, —Si(CH₃)₂—, —(CH₂)ₚ— (wherein 1≦p≦10), —(CF₂)_{q}— (wherein 1≦q≦10), —C(CH₃)₂—, —C(CF₃)₂—, or —C(═O)NH—. In an embodiment, R⁴ is the same or different in each repeating unit and each is independently a halogen, a substituted or unsubstituted C1 to C10 alkoxy group, a substituted or unsubstituted C6 to C15 aryloxy group, a substituted or unsubstituted C2 to C10 ester group (—OC(═O)R²⁰² or —C(═O)OR²⁰³, wherein R²⁰² and R²⁰³ are the same or different and are each independently a C1 to C10 alkyl group), or a carboxyl group. In another embodiment, R⁴ may be hydrogen.

n1 is the same or different in each repeating unit and each is independently an integer ranging from 0 to 5.

The repeating unit A including the repeating unit represented by the Chemical Formula 1 is derived from a styrene derivative including a functional group including a cyano group, an ester group, or a combination thereof, and has excellent or improved heat resistance and moisture resistance and thus, may improve heat resistance and moisture resistance of a polymer for an optical film.

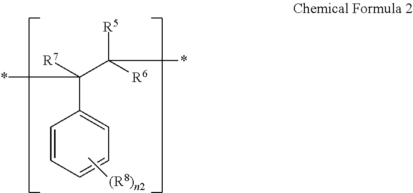

In Chemical Formula 2,

R⁵ to R⁷ are the same or different in each repeating unit and are each independently hydrogen, or a substituted or unsubstituted C1 to C10 aliphatic group. In an embodiment, R⁵ to R⁷ are the same or different in each repeating unit and are each independently hydrogen, or a substituted or unsubstituted C1 to C10 alkyl group.

R⁸ is the same or different in each repeating unit and each is independently a halogen, a substituted or unsubstituted C1 to C30 aliphatic group, a substituted or unsubstituted C3 to C30 alicyclic group, a substituted or unsubstituted C6 to C30 aromatic group, a substituted or unsubstituted C2 to C30 heterocyclic group, a substituted or unsubstituted C1 to C30 alkoxy group, a substituted or unsubstituted C6 to C30 aryloxy group, a substituted or unsubstituted C2 to C30 ester group (—IC(═O)R²⁰⁶ or —C(═O)OR²⁰⁷, wherein R²⁰⁶ and R²⁰⁷ are the same or different and are each independently a C1 to C10 alkyl group), a substituted or unsubstituted C2 to C30 ketone group, a carboxyl group, a cyano group, or —N(R²⁰⁸)(R²⁰⁹) (wherein R²⁰⁸ and R²⁰⁹ are the same or different and are each independently hydrogen, or a substituted or unsubstituted C1 to C10 aliphatic group), wherein the alicyclic group, aromatic group, and heterocyclic group are present singularly; at least two of the alicyclic group, aromatic group, and heterocyclic group are linked to provide a condensed cyclic group; or at least two of the alicyclic group, aromatic group, and heterocyclic group are linked via a single bond, —O—, —S—, —C(═O)—, —CH(OH)—, —S(═O)₂—, —Si(CH₃)₂—, —(CH₂)ₚ— (wherein 1≦p≦10), —(CF₂)_{q}— (wherein 1≦q≦10), —C(CH₃)₂—, —C(CF₃)₂—, or —C(═O)NH—.

In an embodiment, R⁸ is the same or different in each repeating unit and each is independently hydrogen, a halogen, a substituted or unsubstituted C1 to C10 alkoxy group, a substituted or unsubstituted C6 to C15 aryloxy group, a substituted or unsubstituted C2 to C10 ester group (—OC(═O)R²⁰⁶ or —C(═O)OR²⁰⁷, wherein R²⁰⁶ and R²⁰⁷ are the same or different and are each independently a C1 to C10 alkyl group), or a carboxyl group.

n2 in Chemical Formula 2, is the same or different in each repeating unit and each is independently an integer ranging from 0 to 5.

Since the repeating unit B including the repeating unit represented by the Chemical Formula 2 has negative birefringence and excellent moisture resistance, a polymer for an optical film including the same may have improved negative birefringence and moisture resistance. In addition, since polymerization of a monomer for deriving the repeating unit B, such as a styrene-containing monomer, may be easily initiated by a free radical initiator, the polymer for an optical film may be prepared without the use of a metal catalyst and thus may have excellent or improved processability and economic feasibility.

The polymer for an optical film including the repeating units A and B may not only maintain excellent negative birefringence but may also have excellent or improved heat resistance and moisture resistance. Accordingly, an optical film including the polymer for an optical film may have excellent or improved negative birefringence, heat resistance, and moisture resistance.

In an embodiment, the repeating unit represented by the Chemical Formula 1 may include a repeating unit represented by the following Chemical Formulas 3 to 5 or a combination thereof, and the repeating unit represented by the Chemical Formula 2 may include a repeating unit represented by the following Chemical Formulas 6 to 9 or a combination thereof, but they are not limited thereto.

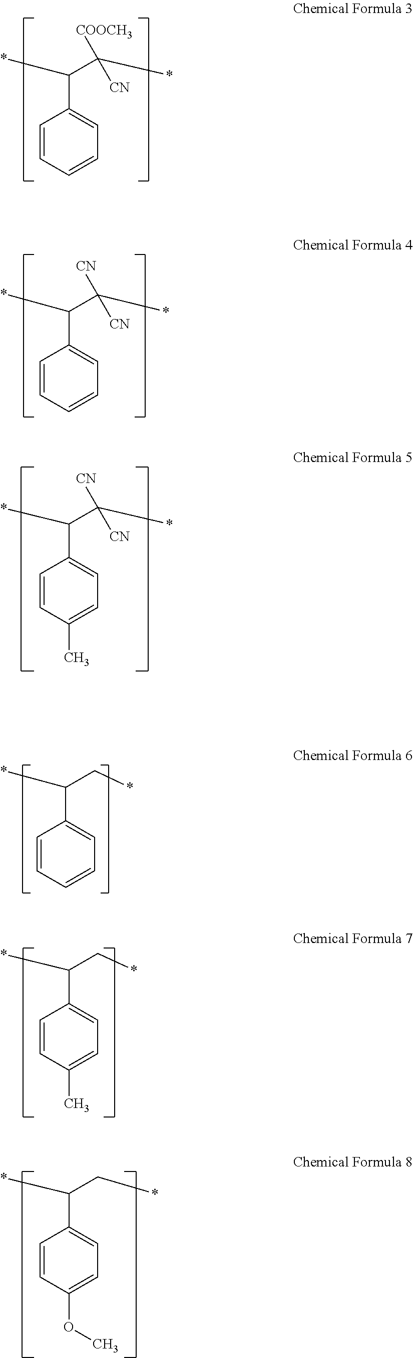

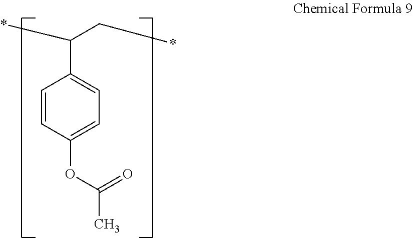

The polymer for an optical film may include the repeating unit A in an amount greater than about 0 (mole percent) mol % and less than or equal to about 50 mol %, specifically about 0.01 mol % to about 50 mol %, and the repeating unit B in an amount of greater than or equal to about 50 mol % and less than about 100 mol %, specifically about 50 mol % to 99.9 mol %, based on a total moles of the repeating units included in the polymer for an optical film.

Other repeating units C may be present in the polymer for an optical film in small amounts (for example, less than 10 mole % of the total moles of units in the polymer), provided that such repeating units C do not significantly adversely affect the desired properties of the polymer for an optical film, in particular negative birefringence, heat resistance, and moisture resistance. In an embodiment, the polymer for an optical film consists essentially of units A and B. In another embodiment, polymer for an optical film consists of units A and B.

When the polymer for an optical film includes the repeating units A and B within the range, negative birefringence, heat resistance, and moisture resistance of the polymer for an optical film may be effectively improved. In an embodiment, the polymer for an optical film may include the repeating unit A in an amount of about 1 mol % to about 30 mol %, specifically about 1 mol % to about 20 mol %, and the repeating unit B in an amount of about 70 mol % to about 99 mol %, specifically about 75 mol % to about 98 mol %, based on the total moles of the repeating units included in the polymer for an optical film.

The polymer for an optical film may have a weight average molecular weight (“Mw”) of about 100,000 grams per mole (g/mol) to about 1,000,000 g/mol. When the polymer for an optical film has a weight average molecular weight within the range, the polymer for an optical film may have a melting viscosity effective to facilitate the formation of a film. In an embodiment, the polymer for an optical film may have a weight average molecular weight (“Mw”) of about 100,000 g/mol to about 400,000 g/mol, and specifically about 100,000 g/mol to about 300,000 g/mol.

The polymer for an optical film may have a number average molecular weight (“Mn”) of about 50,000 g/mol to about 500,000 g/mol. When the polymer for an optical film has a number average molecular weight within the range, the polymer for an optical film may have a melting viscosity effective to facilitate the formation of a film. In an embodiment, the polymer for an optical film may have a number average molecular weight (“Mn”) of about 50,000 g/mol to about 250,000 g/mol, specifically about 50,000 g/mol to about 200,000 g/mol.

The polymer for an optical film may have a polydispersity index (“PDI”) of about 1.1 to about 5.0. When the polymer for an optical film has a polydispersity index within the range, the polymer for an optical film may have excellent or improved quality, reproducibility, and uniformity of the film. In an embodiment, the polymer for an optical film may have a polydispersity index of about 1.2 to about 3.0, specifically about 1.5 to about 2.6.

The polymer for an optical film may have a refractive index of about 1.50 to about 1.65. When the polymer for an optical film has a refractive index within the range, an optical film made of the polymer for an optical film may have an effective phase-difference value. In an embodiment, the polymer for an optical film may have a refractive index of about 1.54 to about 1.61, specifically about 1.55 to about 1.60.

The polymer for an optical film may have glass transition temperature (“T_{g}”) of about 80° C. to about 200° C. When the polymer for an optical film has a glass transition temperature within the range, an optical film made of the polymer for an optical film may have excellent or improved heat resistance. In addition, the polymer for an optical film may have a similar glass transition temperature (“T_{g}”) to that of a widely used positive birefringence resin, and thus may be easily laminated or coextruded with the widely used positive birefringence resin and have a wider process condition range in the elongation process and the like. In an embodiment, the polymer for an optical film may have a glass transition temperature (“T_{g}”) of about 100° C. to about 150° C., specifically about 105° C. to about 140° C.

Accordingly, the polymer for an optical film may be used to fabricate various optical films for a variety of applications including those where a wide viewing angle is desired.

Hereinafter, a method of preparing the polymer for an optical film is described.

In an embodiment, a method of preparing a polymer for an optical film includes contacting (e.g., mixing) a monomer represented by the following Chemical Formula 1-1, a monomer represented by the following Chemical Formula 2-1; and a free radical initiator; and polymerizing the monomers to provide the polymer for an optical film. The contacting may be performed in any order, for example, the monomers may first be combined and the free radical initiator may be added thereto, or the free radical initiator may be combined with any one or more of the monomers prior to addition of the remaining monomers.

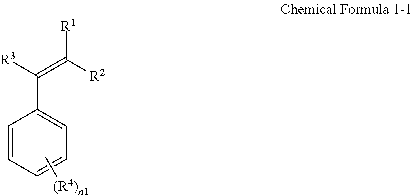

In Chemical Formula 1-1,

R¹, R², R³, R⁴, and n1 are the same as defined in Chemical Formula 1.

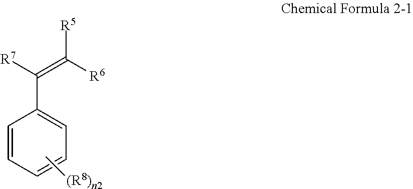

In Chemical Formula 2-1,

R⁵ to R⁸, and n2 are the same as defined in Chemical Formula 2.

Other monomers capable of copolymerizing with monomers represented by Chemical Formulas 1-1 and 1-2 may be present in small amounts (for example, less than 10 mole % of the total moles of monomers), provided that the presence of such monomers do not significantly adversely affect the desired properties of the polymer for an optical film, in particular negative birefringence, heat resistance, and moisture resistance. Such monomers generally contain ethylenic unsaturation, for example various acrylates (e.g., methyl acrylate, ethyl acrylate, n-hexyl acrylate, and the like), methacrylates (e.g., methyl methacrylate, ethyl methacrylate, n-hexyl methacrylate, and the like), vinyl compounds (e.g., vinyl ethers such as methyl vinyl ether and vinyl esters such as vinyl acetate), acrylonitrile, methacrylonitrile, and the like. In an embodiment, the polymerization is conducted with a combination that consists essentially of monomers represented by Chemical Formulas 1-1 and 1-2. In another embodiment, the combination for polymerization consists of monomers represented by Chemical Formulas 1-1 and 1-2.

In an embodiment, the monomer represented by Chemical Formula 1-1 may include a monomer represented by the following Chemical Formulas 10 to 12, or a combination thereof, and the monomer represented by Chemical Formula 2-1 may include a monomer represented by the following Chemical Formulas 13 to 16, or a combination thereof, but they are not limited thereto.

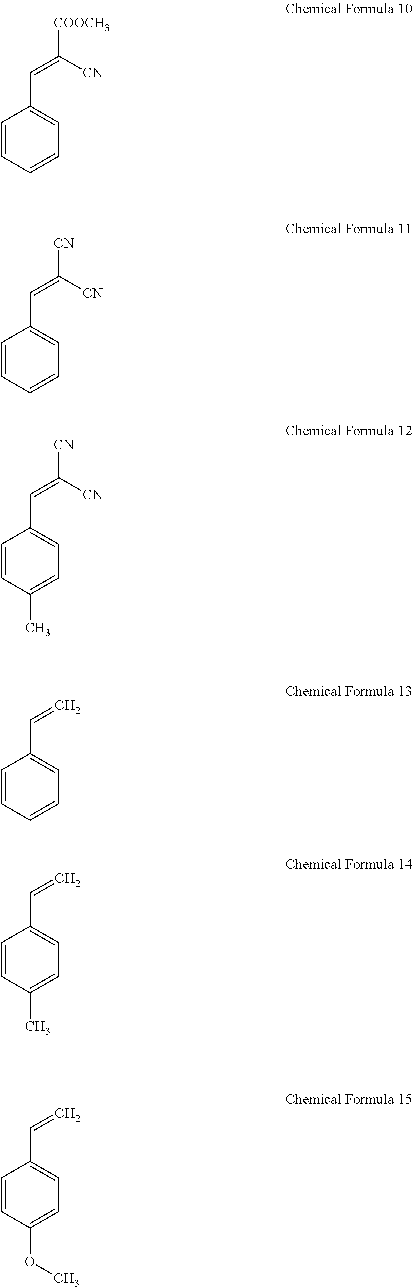

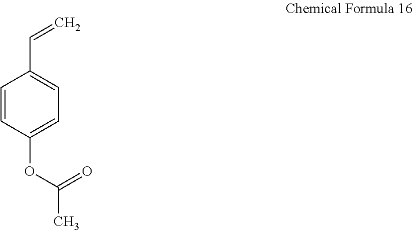

According to an embodiment, the monomer represented by Chemical Formula 1-1, together with the monomer represented by Chemical Formula 2-1, may be combined in a solvent. According to another embodiment, the monomers may be easily combined without a solvent, when the monomer represented by Chemical Formula 2-1 dissolves the monomer represented by Chemical Formula 1-1.

When a solvent is used, the solvent may dissolve the monomers and generate heat and thus, may effectively facilitate polymerization of the monomers. The solvent may be a benzene-containing solvent such as benzene, ethyl benzene, toluene, xylene, cresol, or the like; an aliphatic-containing solvent such as pentane, cyclopentane, hexane, cyclohexane, heptane, or the like; a halogen-containing solvent such as methylene chloride, chloroform, or the like; tetrahydrofuran; ethylacetate; dimethyl formamide; dimethyl acetamide; diethyl ether; petroleum ether; dimethylsulfoxide; acetonitrile; methanol; ethanol; or the like. Each of the foregoing solvents may be used singularly or as a combination, but is not limited thereto.

When the monomer represented by Chemical Formula 1-1 is combined with the monomer represented by Chemical Formula 2-1 and a free radical initiator, the monomers may be easily polymerized by the free radical initiator, for example a peroxide-containing initiator, to form the polymer for an optical film without the use of a metal catalyst. Polymers formed under these conditions have excellent or improved processability and economic feasibility.

According to another embodiment, a metal catalyst instead of the free radical initiator may be used as an initiator, but it may make it difficult to control a manufacturing process, and makes the process complex, deteriorating processability and economic feasibility. In addition, it is possible the metal catalyst may not be completely refined, i.e., purified, and some of the impurities or metal catalyst residue may remain, which may scatter light and be seen as a color stain.

According to an embodiment, the free radical initiator may be a peroxide-containing initiator, an azo-containing initiator, or a combination thereof.

The peroxide-containing initiator may include a substituted or unsubstituted arylperoxide, a substituted or unsubstituted alkylperoxide, a substituted or unsubstituted hydroperoxide, a substituted or unsubstituted peroxy ester, a substituted or unsubstituted peroxy carbonate, or a combination thereof. According to an embodiment, the peroxide-containing initiator may include benzoyl peroxide, t-butylperoxy-2-ethyl hexanoate, dicumyl peroxide, t-butyl peroxide, 1,1-di(t-butylperoxy)cyclohexane, dibenzoyl peroxide, 2-butanone peroxide, t-butyl perbenzoate, 2,5-bis(t-butylperoxy)-2,5-dimethylhexane, bis(t-butylperoxyisopropyl)benzene, t-butyl hydroperoxide, or a combination thereof, but is not limited thereto.

The azo-containing initiator may include 2,2′-azobisisobutyronitrile (“AIBN”), 1,1′-azobis(cyclohexanecarbonitrile), 4,4-azobis(4-cyanovaleric acid), 2,2′-azobis(4-methoxy-2,4-dimethylvaleronitrile), 4,4′-azobis(4-cyanovaleric) acid, 2,2′-azobis[2-methyl-N-(1,1-bis(hydroxymethyl)-2-hydroxyethyl)propionamide], 2′-azobis[2-methyl-N-(2-hydroxyethyl)propionamide], or a combination thereof.

The free radical initiator, for example the peroxide-containing initiator may be used in an amount of about 0.001 parts by weight to about 10 parts by weight based on 100 parts by weight of the total weight of all monomers.

The polymerization may be performed at a temperature effective to initiate polymerization (i.e., effective to thermally decompose the free radical initiator), for example at a temperature ranging from about 60° C. to about 200° C., specifically about 70° C. to about 150° C., and more specifically about 80° C. to about 150° C. The polymerization may be performed with a reaction time ranging from about 1 hour to about 48 hours, specifically about 10 hours to about 24 hours, and more specifically about 12 hours to about 20 hours. When the polymerization is performed within the foregoing process condition ranges, the polymer may have a desired weight average molecular weight, number average molecular weight, dispersibility, and a stable polymerization yield may be achieved, for example, a polymerization yield of greater than or equal to about 60%, specifically greater than or equal to about 65%, more specifically greater than or equal to about 70%.

When the monomer represented by Chemical Formula 1-1 and the monomer represented by Chemical Formula 2-1 are combined, the monomer represented by Chemical Formula 1-1 may be combined in an amount of greater than about 1 mol % and less than or equal to about 50 mol %, and the monomer represented by Chemical Formula 2-1 may be combined in an amount of greater than or equal to about 50 mol % and less than about 100 mol %, based on a total moles of the monomers.

When each monomer is combined within the foregoing ranges, the monomers may be effectively polymerized by the free radical initiator, for example the peroxide-containing initiator and negative birefringence, heat resistance, and moisture resistance of the resulting polymer for an optical film may be effectively improved. In an embodiment, the monomer represented by Chemical Formula 1-1 may be combined in an amount of about 1 mol % to about 30 mol %, specifically about 1 mol % to about 20 mol %, and the monomer represented by Chemical Formula 2-1 may be combined in an amount of about 70 mol % to about 99 mol %, specifically about 75 mol % to about 98 mol %, based on a total moles of the monomers.

According to another embodiment, an optical film including the polymer for an optical film is provided.

The optical film includes the polymer for an optical film and thus, has excellent or improved negative birefringence, heat resistance, and moisture resistance.

The optical film has an in-plane phase-difference value (“Rₑ”) ranging from about 0 nanometers (nm) to about 500 nm at a wavelength of about 550 nm. When the optical film has an in-plane phase-difference value (“Rₑ”) within the range, it may be effectively used for various applications, including optical devices. In an embodiment, the optical film may have an in-plane phase-difference value (“Rₑ”) ranging from about 50 nm to about 200 nm at a wavelength of about 550 nm, more specifically from about 75 nm to about 175 nm at a wavelength of about 550 nm.

The optical film has a thickness direction phase-difference value (“Rₜₕ”) ranging from about 0 nm to about −1000 nm at a wavelength of about 550 nm. When the optical film has a thickness direction phase-difference value (“Rₜₕ”) within the range, it may be effectively used for various applications, including optical devices. In an embodiment, the optical film may have a thickness direction phase-difference value (“Rₜₕ”) ranging from about 0 nm to about −500 nm at a wavelength of about 550 nm, more specifically from about 0 nm to about −300 nm at a wavelength of about 550 nm.

The optical film may have a short wavelength dispersion of the in-plane phase-difference value (“Rₑ”) (450 nm/550 nm) ranging from about 1.00 to about 1.20, specifically about 1.00 to about 1.18, and more specifically about 1.00 to about 1.16. In addition, the optical film may have long wavelength dispersion of the in-plane phase-difference value (“Rₑ”) (650 nm/550 nm) ranging from about 0.90 to about 1.00, specifically about 0.92 to about 1.00, and more specifically about 0.94 to about 0.99. Herein, the short wavelength dispersion of the in-plane phase-difference value (“Rₑ”) (450 nm/550 nm) is obtained by dividing an in-plane phase-difference value (“Rₑ”) at a wavelength of about 450 nm by an in-plane phase-difference value (“Rₑ”) at a wavelength of about 550 nm. The long wavelength dispersion of the in-plane phase-difference value (“Rₑ”) (650 nm/550 nm) is obtained by dividing an in-plane phase-difference value (“Rₑ”) at a wavelength of about 650 nm by an in-plane phase-difference value (“Rₑ”) at a wavelength of about 550 nm. When the optical film has the short and long wavelength dispersions within the foregoing ranges, it may have effective negative birefringence, and then may be mixed with positive birefringence, thus exhibiting effective reverse wavelength dispersion.

The optical film may have an average light transmittance of greater than or equal to about 80% at a wavelength ranging from about 380 nm to about 780 nm. When the optical film has light transmittance within the foregoing range, the optical film may not deteriorate luminescence characteristics and color reproducibility. In an embodiment, the optical film may have an average light transmittance of greater than or equal to about 90% at a wavelength ranging from about 380 nm to about 780 nm, more specifically greater than or equal to about 93% at a wavelength ranging from about 380 nm to about 780 nm.

The optical film may have a haze of less than or equal to about 5%. When the optical film has a haze within the foregoing range, the optical film may be effectively transparent and may have excellent or improved clarity. In an embodiment, the optical film may have a haze of less than or equal to about 3%, and more specifically, less than or equal to about 1%.

The optical film may have a yellow index (“YI”) of less than or equal to about 5.0. When the optical film has a yellow index (“YI”) within the foregoing range, it may be transparent and colorless. In an embodiment, the optical film may have a yellow index (“YI”) ranging from about 0.5 to about 5.0, more specifically about 0.1 to about 3.0.

The optical film may have a thickness ranging from about 0.01 micrometers (μm) to about 1,000 μm, specifically about 1 μm to about 500 μm, more specifically about 10 μm to about 100 μm, but is not limited thereto, and the thickness may be adjusted depending on the application of the optical film.

The optical film may have a glass transition temperature (“T_{g}”) of about 80° C. to about 200° C. When the optical film has a glass transition temperature within the foregoing range, it may have excellent or improved heat resistance and a wider process condition range in the elongation process and the like. In an embodiment, the optical film may have a glass transition temperature (“T_{g}”) of about 100° C. to about 150° C., and more specifically about 105° C. to about 145° C.

The optical film may be fabricated by melting the polymer for an optical film or dissolving it in an organic solvent (for example a solvent as described above for polymerization, such as toluene, methyl isobutyl ketone, cyclopentanone, methylene chloride, 1,2-dichloroethane, methyl amyl ketone, methyl ethyl ketone, methyl isoamyl ketone, or combinations thereof), spin-coating, spray coating, roll coating, curtain coating, dip coating, or a combination thereof, and placing the melted polymer or the polymer solution in a mold and compressing the polymer in the mold to form a polymer sheet, and elongating the polymer sheet to provide the optical film. A cast polymer or polymer solution may also be compressed using a nip roller, for example. According to an embodiment, the elongating of the sheet may be performed in a direction of one axis or performed sequentially or simultaneously in a direction of two axes. A main chain of the polymer is aligned in an elongation axis direction by the elongating process, and the repeating unit A including the repeating unit represented by Chemical Formula 1 and the repeating unit B including a repeating unit represented by the above Chemical Formula 2, in a perpendicular direction to the alignment axis of the main chain of the polymer, such that the elongated sheet, i.e., the optical film may effectively show negative birefringence.

The sheet may be fabricated by compressing the melted polymer or the polymer solution with a high pressure at a temperature ranging from about 200° C. to about 300° C., specifically about 210° C. to about 290° C., more specifically at about 225° C. to about 275° C. According to another embodiment, the sheet may be fabricated by discharging the melted polymer or the polymer solution in a chill roll through a T-die, without limitation.

The sheet may be elongated at a temperature ranging from about 100° C. to about 150° C., specifically about 105° C. to about 145° C., and more specifically about 110° C. to about 135° C.

According to an embodiment, the sheet may be elongated at an elongation rate ranging from about 10% to about 300%, specifically about 20% to about 200%, and more specifically, about 20% to about 100%. According to an embodiment, the elongation rate may be calculated according to the following Equation 1.

Elongation rate(%)=(L−L₀/L₀)×100 Equation 1

In Equation 1,

L₀ refers to a length of a sheet before the elongation, and

L refers to a length of a sheet after the elongation.

The optical film may be formed into a single layer or multilayer by using the polymer for an optical film as a negative birefringence polymer. According to an embodiment, a film including a positive birefringence polymer that is known for use in a related field, for example, a polyethylene terephthalate, a polyethylene naphthalate, a cyclic olefin polymer (“COP”), may be laminated on a surface of the optical film to provide an optical film product. Accordingly, the resulting optical film product may have reverse wavelength dispersibility and thus may form a compensation film capable of complementing wide viewing angle. The optical film may have reverse wavelength dispersibility, and thus may prevent color shift, but increase a contrast ratio.

However, the optical film is not limited thereto but may be formed into a single layer or multilayer by combining (e.g., blending or copolymerizing) the negative birefringence polymer and a positive birefringence polymer known for use in a related field, e.g., optical films, such as polyethylene terephthalate and polyethylene naphthalate, and then forming a film from the combination. According to an embodiment, the optical film thus formed may be as a compensation film.

According to another embodiment a display device including the optical film is provided. In an embodiment, the display device may be a liquid crystal display (“LCD”), an organic light emitting diode (“OLED”) device, and the like, but is not limited thereto.

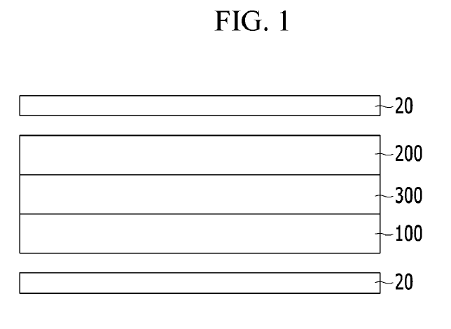

According to an embodiment, a liquid crystal display (“LCD”) including the optical film is described referring to FIG. 1.

FIG. 1 is a cross-sectional view showing an LCD according to an embodiment.

Referring to FIG. 1, the LCD according to an embodiment includes a liquid crystal display panel, including a first display panel 100, a second display panel 200, and a liquid crystal layer 300 interposed (i.e., disposed) between the first display panel 100 and the second display panel 200, and an optical film 20 disposed on both a lower part, e.g. a first display panel 100, opposite a liquid crystal layer 300, and an upper part, e.g. a second display panel 200, opposite the liquid crystal layer 300, of the liquid crystal display panel.

The liquid crystal display panel may be a twisted nematic (“TN”) mode panel, a patterned vertical alignment (“PVA”) mode panel, or the like, but is not limited thereto.

The first display panel 100 may include, for example, a thin film transistor (“TFT”, not shown) and a first field generating electrode (not shown) connected to the TFT, sequentially disposed on a substrate (not shown). The second display panel 200 may include, for example, a color filter (not shown) and a second field generating electrode (not shown), sequentially disposed on the substrate.

The liquid crystal layer 300 may include a plurality of liquid crystal molecules. The liquid crystal molecules may have positive or negative dielectric anisotropy. When the liquid crystal molecules have positive dielectric anisotropy, the long axis of the liquid crystal molecules may be aligned substantially parallel to a surface of the first display panel 100 and the second display panel 200 when not applying an electric field, and may be aligned substantially perpendicular to a surface of the first display panel 100 and the second display panel 200 when applying an electric field.

According to another embodiment, when the liquid crystal molecules have negative anisotropy, the long axis thereof may be aligned substantially perpendicular to a surface of the first display panel 100 and the second display panel 200 when not applying an electric field, and may be aligned substantially parallel to a surface of the first display panel 100 and the second display panel 200 when applying an electric field.

The optical films 20 are disposed on an outside surface of the liquid crystal display panel. Referring to FIG. 1, although the optical films 20 are shown to be disposed on both the upper part, e.g. the second display panel 200, opposite the liquid crystal layer 300, and lower part, e.g. the first display panel 100, opposite the liquid crystal layer 300, of the liquid crystal display panel, in an alternative embodiment (not shown) the optical film 20 may be disposed on either the upper part, or the lower part, of liquid crystal display panel.

As described above, the optical film 20 may be an elongated film including the polymer for an optical film including a repeating unit A including a repeating unit represented by Chemical Formula 1; and a repeating unit B including a repeating unit represented by Chemical Formula 2, and may act as a compensation film.

### EXAMPLES

Hereinafter, the embodiments are illustrated in more detail with reference to examples. However, the following are exemplary embodiments of the disclosure, and the disclosure is not limited thereto.

### Example 1

### Preparation of Polymer for Optical Film

About 15.4 grams (g) (about 100 millimoles (mmol)) of compound represented by the following Chemical Formula 11 (benzylidenemalononitrile, purchased from Sigma-Aldrich), about 52.075 g (about 500 mmol) of styrene, and about 80 g of toluene are mixed.

Then about 162.5 mg (about 0.5 mmol) of perhexa C-40 (79% purity, manufactured by NOF, Japan) is added thereto and agitated and reacted for about 19 hours while refluxing under a nitrogen (N₂) atmosphere at about 110° C., to provide a polymer for an optical film. The yield is about 78.5%.

The obtained polymer for an optical film has a weight average molecular weight (“Mw”) of about 112,000 g/mol, a number average molecular weight (“Mn”) of about 50,000 g/mol, and a polydispersity index of about 2.24. The obtained polymer for an optical film has a refractive index of about 1.57.

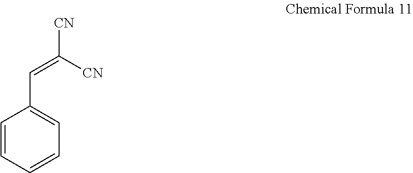 [SMILES: N#CC(C#N)=Cc1ccccc1]

### Example 2

### Preparation of Polymer for Optical Film

About 77.1 g (about 500 mmol) of compound represented by Chemical Formula 11, about 52.075 g (about 500 mmol) of styrene, and about 80 g of toluene are mixed.

Then about 162.5 mg (about 0.5 mmol) of perhexa C-40 (79% purity, manufactured by NOF, Japan) is added thereto and agitated and reacted for about 19 hours while refluxing under a nitrogen (N₂) atmosphere at about 110° C., to provide a polymer for an optical film. The yield is about 50%.

The obtained polymer for an optical film has a weight average molecular weight (“Mw”) of about 129,757 g/mol, a number average molecular weight (“Mn”) of about 74,404 g/mol, and a polydispersity index of about 1.74. The obtained polymer for an optical film has a refractive index of about 1.57.

### Example 3

### Preparation of Polymer for Optical Film

About 84 g (about 500 mmol) of compound represented by Chemical Formula 11, about 77.1 g (about 500 mmol) of compound represented by the following Chemical Formula 15 (4-vinylanisole, purchased from Sigma-Aldrich), and about 80 g of toluene are mixed.

Then about 162.5 mg (about 0.5 mmol) of perhexa C-40 (79% purity, manufactured by NOF, Japan) is added thereto and agitated and reacted for about 19 hours while refluxing under a nitrogen (N₂) atmosphere at about 110° C., to provide a polymer for an optical film. The yield is about 55%.

The obtained polymer for an optical film has a weight average molecular weight

(“Mw”) of about 269,977 g/mol, a number average molecular weight (“Mn”) of about 140,564 g/mol, and a polydispersity index of about 1.92. The obtained polymer for an optical film has a refractive index of about 1.57.

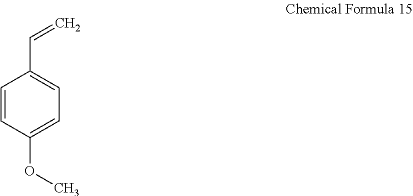

### Example 4

### Preparation of Polymer for Optical Film

The trisubstituted ethylene monomer represented by the following Chemical Formula 12, is synthesized by a condensation of p-tolualdehyde (purchased from Sigma-Aldrich) with malononitrile, catalyzed by base, piperidine (purchased from Sigma-Aldrich), as represented by the following chemical reaction.

p-CH₃-PhCHO+NCCH₂CN→p-CH₃-PhCH═C(CN)₂

Malononitrile (1 mol, 66.06 g) and p-tolualdehyde (1 mol, 120.15 g) are mixed with 10 g of DMF in an Erlenmeyer flask. 40 Milligrams (mg) of piperidine is added with stirring. The crystalline product of the reaction is isolated by filtration and purified by crystallization from 2-propanol, to provide a compound represented by the following Chemical Formula 12.

About 16.8 g (about 100 mmol) of compound represented by the following Chemical Formula 12, about 93.735 g (about 900 mmol) of styrene, and about 80 g of toluene are mixed.

Then about 162.5 mg (about 0.5 mmol) of perhexa C-40 (79% purity, manufactured by NOF, Japan) is added thereto and agitated and reacted for about 19 hours while refluxing under a nitrogen (N₂) atmosphere at about 110° C., to provide a polymer for an optical film. The yield is about 85.7%.

The obtained polymer for an optical film has a weight average molecular weight (“Mw”) of about 151,000 g/mol, a number average molecular weight (“Mn”) of about 73,000 g/mol, and a polydispersity index of about 2.07. The obtained polymer for an optical film has a refractive index of about 1.58.

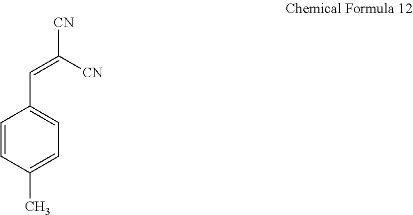

### Example 5

### Preparation of Polymer for Optical Film

The trisubstituted ethylene monomer, represented by the following Chemical Formula 10 is synthesized by a condensation of benzaldehyde (purchased from Sigma-Aldrich) with methyl cyanoacetate, catalyzed by base, piperidine (purchased from Sigma-Aldrich), as represented by the following chemical reaction.

PhCHO+NCCH₂CO₂CH₃→PhCH═C(CN)(CO₂CH₃)

Methyl cyanoacetate (1 mol, 99.09 g) and benzaldehyde (1 mol, 106.12 g) are mixed with 10 g of DMF in an Erlenmeyer flask. 40 mg of piperidine is added with stirring. The crystalline product of the reaction is isolated by filtration and purified by crystallization from 2-propanol, to provide a compound represented by the following Chemical Formula 10.

About 4.68 g (about 25 mmol) of compound represented by the following Chemical Formula 10, about 10.42 g (about 100 mmol) of styrene, and about 15 g of toluene are mixed.

Then about 40.6 mg (about 0.125 mmol) of perhexa C-40 (79% purity, manufactured by NOF, Japan) is added thereto and agitated and reacted for about 19 hours while refluxing under a nitrogen (N₂) atmosphere at about 110° C., to provide a polymer for an optical film. The yield is about 93.7%.

The obtained polymer for an optical film has a weight average molecular weight (“Mw”) of about 164,000 g/mol, a number average molecular weight (“Mn”) of about 85,000 g/mol, and a polydispersity index of about 1.93. The obtained polymer for an optical film has a refractive index of about 1.57.

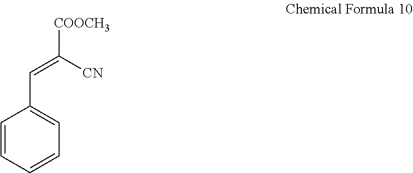 [SMILES: COC(=O)/C(C#N)=C/c1ccccc1]

### Example 6

### Preparation of Polymer for Optical Film

About 9.361 g (about 50 mmol) of compound represented by Chemical Formula 10, about 10.415 g (about 100 mmol) of styrene, and about 21.75 g of toluene are mixed.

Then about 49.4 mg (about 0.15 mmol) of perhexa C-40 (79% purity, manufactured by NOF, Japan) is added thereto and agitated and reacted for about 19 hours while refluxing under a nitrogen (N₂) atmosphere at about 110° C., to provide a polymer for an optical film. The yield is about 94.6%.

The obtained polymer for an optical film has a weight average molecular weight (“Mw”) of about 219,000 g/mol, a number average molecular weight (“Mn”) of about 106,000 g/mol, and a polydispersity index of about 2.07. The obtained polymer for an optical film has a refractive index of about 1.58.

### Example 7

### Preparation of Polymer for Optical Film

About 5.616 g (about 30 mmol) of compound represented by Chemical Formula 10, about 25 g (about 240 mmol) of styrene, and about 33.7 g of toluene are mixed.

Then about 87.8 mg (about 0.27 mmol) of perhexa C-40 (79% purity, manufactured by NOF, Japan) is added thereto and agitated and reacted for about 19 hours while refluxing under a nitrogen (N₂) atmosphere at about 110° C., to provide a polymer for an optical film. The yield is about 92.2%.

The obtained polymer for an optical film has a weight average molecular weight (“Mw”) of about 155,000 g/mol, a number average molecular weight (“Mn”) of about 67,000 g/mol, and a polydispersity index of about 2.31. The obtained polymer for an optical film has a refractive index of about 1.57.

### Example 8

### Preparation of Polymer for Optical Film

About 3.74 g (about 20 mmol) of compound represented by Chemical Formula 10, about 20.83 g (about 200 mmol) of styrene, and about 27.03 g of toluene are mixed.

Then about 72.4 mg (about 0.22 mmol) of perhexa C-40 (79% purity, manufactured by NOF, Japan) is added thereto and agitated and reacted for about 19 hours while refluxing under a nitrogen (N₂) atmosphere at about 110° C., to provide a polymer for an optical film. The yield is about 94.4%.

The obtained polymer for an optical film has a weight average molecular weight (“Mw”) of about 181,000 g/mol, a number average molecular weight (“Mn”) of about 92,000 g/mol, and a polydispersity index of about 1.98. The obtained polymer for an optical film has a refractive index of about 1.58.

### Example 9

### Preparation of Polymer for Optical Film

About 3.744 g (about 20 mmol) of compound represented by Chemical Formula 10, about 39.577 g (about 380 mmol) of styrene, and about 44 g of toluene are mixed.

Then about 130 mg (about 0.4 mmol) of perhexa C-40 (79% purity, manufactured by NOF, Japan) is added thereto and agitated and reacted for about 19 hours while refluxing under a nitrogen (N₂) atmosphere at about 110° C., to provide a polymer for an optical film. The yield is about 85.7%.

The obtained polymer for an optical film has a weight average molecular weight (“Mw”) of about 149,000 g/mol, a number average molecular weight (“Mn”) of about 70,000 g/mol, and a polydispersity index of about 2.13. The obtained polymer for an optical film has a refractive index of about 1.58.

### Example 10

### Preparation of Polymer for Optical Film

About 0.936 g (about 5 mmol) of compound represented by Chemical Formula 10, about 12.747 g (about 95 mmol) of compound represented by Chemical Formula 15, and about 14 g of toluene are mixed.

Then about 32.5 mg (about 0.1 mmol) of perhexa C-40 (79% purity, manufactured by NOF, Japan) is added and agitated and reacted for about 19 hours while refluxing under a nitrogen (N₂) atmosphere at about 110° C., to provide a polymer for an optical film. The yield is about 77%.

The obtained polymer for an optical film has a weight average molecular weight (“Mw”) of about 128,000 g/mol, a number average molecular weight (“Mn”) of about 54,000 g/mol, and a polydispersity index of about 2.37. The obtained polymer for an optical film has a refractive index of about 1.58.

### Example 11

### Preparation of Polymer for Optical Film

About 0.936 g (about 5 mmol) of compound represented by Chemical Formula 10, about 15.41 g (about 95 mmol) of compound represented by Chemical Formula 16 (4-acetoxystyrene, purchased from Sigma-Aldrich), and about 16.4 g of toluene are mixed.

Then about 32.5 mg (about 0.1 mmol) of perhexa C-40 (79% purity, manufactured by NOF, Japan) is added thereto and agitated and reacted for about 19 hours while refluxing under a nitrogen (N₂) atmosphere at about 110° C., to provide a polymer for an optical film. The yield is about 92.4%.

The obtained polymer for an optical film has a weight average molecular weight (“Mw”) of about 276,000 g/mol, a number average molecular weight (“Mn”) of about 112,000 g/mol, and a polydispersity index of about 2.46. The obtained polymer for an optical film has a refractive index of about 1.57.

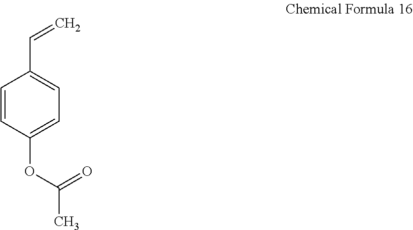

### Example 12

### Preparation of Polymer for Optical Film

About 2.808 g (about 15 mmol) of compound represented by Chemical Formula 10, about 14.181 g (about 120 mmol) of compound represented by Chemical Formula 14 (4-methylstyrene, purchased from Sigma-Aldrich), and about 18 g of toluene are mixed.

Then about 43.9 mg (about 0.135 mmol) of perhexa C-40 (79% purity, manufactured by NOF, Japan) is added thereto and agitated and reacted for about 19 hours while refluxing under a nitrogen (N₂) atmosphere at about 110° C. to provide a polymer for an optical film. The yield is about 91.8%.

The obtained polymer for an optical film has a weight average molecular weight (“Mw”) of about 215,000 g/mol, a number average molecular weight (“Mn”) of about 96,000 g/mol, and a polydispersity index of about 2.24. The obtained polymer for an optical film has a refractive index of about 1.56.

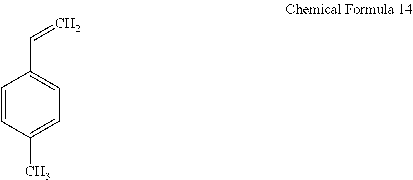

### Comparative Example 1

### Preparation of Polymer for Optical Film

A polymer for an optical film is prepared in accordance with the same procedure as in Example 1, except that about 9.81 g (about 100 mmol) of compound represented by In Chemical Formula 17 (maleic anhydride, purchased from Sigma-Aldrich) is used instead of about 15.4 g (about 100 mmol) of compound represented by the following Chemical Formula 11. The yield is about 60%.

The obtained polymer for an optical film has a weight average molecular weight (“Mw”) of about 212,000 g/mol, a number average molecular weight (“Mn”) of about 89,000 g/mol, and a polydispersity index of about 2.38. The obtained polymer for an optical film has a refractive index of about 1.58.

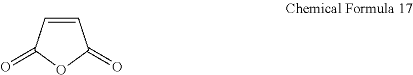

### Example 13

### Preparation of Optical Film

The polymer for an optical film according to Example 1 is melted at about 250° C., and then, put in a mold and compressed to form a sheet.

Then, the sheet is about 30% elongated at about 130° C., and cooled down to a room temperature, fabricating an optical film.

### Examples 14 to 24

### Preparation of Optical Film

Optical films are fabricated according to the same method as in Example 13 except for using the polymer for an optical film according to Examples 2 to 12, respectively instead of the polymer for an optical film according to Example 1. Each refers to Examples 14 to 24, sequentially.

### Comparative Example 2

### Preparation of Optical Film

The polymer for an optical film according to Comparative Example 1 is melted at about 250° C., and then, put in a mold and compressed to form a sheet.

Then, the sheet is about 180% elongated at about 150° C., and cooled down to a room temperature, fabricating an optical film.

### Experimental Example 1

### Glass Transition Temperature

About 10 mg of the polymer for an optical film according to Examples 1 to 9 and Comparative Examples 1 is respectively put on the holder of a differential scanning calorimeter (“DSC”) equipment (METTLER TOLEDO Inc., Switzerland), scanned primarily at a speed of about 10° C. per minute (° C./min) at a temperature ranging from about 30° C. to about 150° C., and secondarily at a temperature ranging from about 30° C. to about 300° C., and measured regarding glass transition temperature. The results are provided in the following Table 1.

In the following Table 1, “NA” means that the glass transition temperature cannot be measured.

TABLE 1

| | Glass transition temperature (° C.) |
|---|---|
| Example 1 | 128 |
| Example 2 | NA |
| Example 3 | NA |
| Example 4 | NA |
| Example 5 | 168 |
| Example 6 | 205 |
| Example 7 | 140 |
| Example 8 | 135 |
| Example 9 | 95 |
| Example 10 | 102 |
| Example 11 | 130 |
| Example 12 | generally broad |
| Comparative Example 1 | 124 |

Referring to Table 1, the polymers for an optical film according to Example 1, Examples 5 to 11, and Example 12 have a glass transition temperature ranging from about 95° C. to about 205° C., which is similar to the glass transition temperature of a known for use positive birefringence polymer, resulting in little if any difference between the glass transition temperature of the polymer for an optical film and the positive birefringence polymer. Thus the resulting polymer for an optical film, may solve a problem that arises when a glass transition temperature (“T_{g}”) difference exists between the polymer for an optical film and the positive birefringence polymer.

### Experimental Example 2

### Wavelength Disperse

The optical films according to Examples 13 to 24 and Comparative Example 2 are each cut into a size of 1 centimeter (cm)×1 cm specimen and the specimen disposed on Axoscan (manufactured by Axometrics, USA) and measured for a short wavelength dispersion (“SWD”) and a long wavelength dispersion (“LWD”) of the specimen at a wavelength ranging from about 400 nm to about 700 nm. Herein, the reference wavelength is about 550 nm.

The results of Examples 18 to 21 and Comparative Example 2 are provided in the following Table 2.

TABLE 2

| | Wavelength dispersion | |
|---|---|---|
| | SWD* (450 nm/550 nm) | LWD** (650 nm/550 nm) |
| Example 18 | 1.065 | 0.966 |
| Example 19 | 1.051 | 0.968 |
| Example 20 | 1.069 | 0.969 |
| Example 21 | 1.06 | 0.97 |
| Comparative | 1.06 | 0.96 |
| Example 2 | | |

*SWD: short wavelength dispersion of the in-plane phase-difference value (“Rₑ”)
**LWD: long wavelength dispersion of the in-plane phase-difference value (“Rₑ”)

Referring to Table 2, the optical films according to Examples 18 to 21 have a short wavelength dispersion of the in-plane phase-difference value (“Rₑ”) (450 nm/550 nm) ranging from about 1.00 to about 1.20, respectively, and a long wavelength dispersion of the in-plane phase-difference value (“Rₑ”) (650 nm/550 nm) ranging from about 0.90 to about 1.00, respectively, resulting in a variety of negative birefringence and wavelength dispersion slopes.

While this disclosure has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A polymer for an optical film, comprising:
a repeating unit A represented by the following Chemical Formula 1; and
a repeating unit B represented by the following Chemical Formula 2: 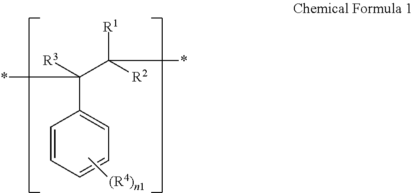
wherein, in Chemical Formula 1,
R¹ and R² are the same or different in each repeating unit and are each independently hydrogen, a substituted or unsubstituted C1 to C10 aliphatic group, —CN, or —C(═O)OR²⁰⁰, wherein R²⁰⁰ is a substituted or unsubstituted C1 to C30 aliphatic group, a substituted or unsubstituted C3 to C30 alicyclic group, a substituted or unsubstituted C6 to C30 aromatic group, or a substituted or unsubstituted C2 to C30 heterocyclic group, wherein at least one of R¹ and R² is —CN or —C(═O)OR²⁰⁰,
R³ is the same or different in each repeating unit and each is independently hydrogen, a substituted or unsubstituted C1 to C10 aliphatic group, —CN, or —C(═O)OR²⁰¹, wherein R²⁰¹ is a substituted or unsubstituted C1 to C30 aliphatic group, a substituted or unsubstituted C3 to C30 alicyclic group, a substituted or unsubstituted C6 to C30 aromatic group, or a substituted or unsubstituted C2 to C30 heterocyclic group,
R⁴ is the same or different in each repeating unit and each is independently a halogen, a substituted or unsubstituted C1 to C30 aliphatic group, a substituted or unsubstituted C3 to C30 alicyclic group, a substituted or unsubstituted C6 to C30 aromatic group, a substituted or unsubstituted C2 to C30 heterocyclic group, a substituted or unsubstituted C1 to C30 alkoxy group, a substituted or unsubstituted C6 to C30 aryloxy group, a substituted or unsubstituted C2 to C30 ester group (—OC(═O)R²⁰² or —C(═O)OR²⁰³, wherein R²⁰² and R²⁰³ are the same or different and are each independently a C1 to C10 alkyl group), a substituted or unsubstituted C2 to C30 ketone group, a carboxyl group, a cyano group, or —N(R²⁰⁴)(R²⁰⁵) (wherein R²⁰⁴ and R²⁰⁵ are the same or different and are each independently hydrogen, or a substituted or unsubstituted C1 to C10 aliphatic group), wherein the alicyclic group, aromatic group, and heterocyclic group are present singularly; at least two of the alicyclic group, aromatic group, and heterocyclic group are linked to provide a condensed cyclic group; or at least two of the alicyclic group, aromatic group, and heterocyclic group are linked via a single bond, —O—, —S—, —C(═O)—, —CH(OH)—, —S(═O)₂—, —Si(CH₃)₂—, —(CH₂)ₚ— (wherein 1≦p≦10), —(CF₂)_{q}— (wherein 1≦q≦10), —C(CH₃)₂—, —C(CF₃)₂—, or —C(═O)NH—, and
n1 is the same or different in each repeating unit and each is independently an integer ranging from 0 to 5, 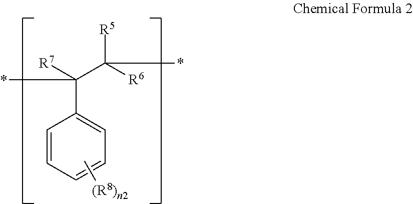
wherein, in Chemical Formula 2,
R⁵ to R⁷ are the same or different in each repeating unit and are each independently hydrogen, or a substituted or unsubstituted C1 to C10 aliphatic group,
R⁸ is the same or different in each repeating unit and each is independently a halogen, a substituted or unsubstituted C1 to C30 aliphatic group, a substituted or unsubstituted C3 to C30 alicyclic group, a substituted or unsubstituted C6 to C30 aromatic group, a substituted or unsubstituted C2 to C30 heterocyclic group, a substituted or unsubstituted C1 to C30 alkoxy group, a substituted or unsubstituted C6 to C30 aryloxy group, a substituted or unsubstituted C2 to C30 ester group (—OC(═O)R²⁰⁶ or —C(═O)OR²⁰⁷, wherein R²⁰⁶ and R²⁰⁷ are the same or different and are each independently a C1 to C10 alkyl group), a substituted or unsubstituted C2 to C30 ketone group, a carboxyl group, a cyano group, or —N(R²⁰⁸)(R²⁰⁹) (wherein R²⁰⁸ and R²⁰⁹ are the same or different and are each independently hydrogen, or a substituted or unsubstituted C1 to C10 aliphatic group), wherein the alicyclic group, aromatic group, and heterocyclic group are present singularly; at least two of the alicyclic group, aromatic group, and heterocyclic group are linked to provide a condensed cyclic group; or at least two of the alicyclic group, aromatic group, and heterocyclic group are linked via a single bond, —O—, —S—, —C(═O)—, —CH(OH)—, —S(═O)₂—, —Si(CH₃)₂—, —(CH₂)ₚ— (wherein 1≦p≦10), —(CF₂)_{q}— (wherein 1≦q≦10), —C(CH₃)₂—, —C(CF₃)₂—, or —C(═O)NH—, and
n2 is the same or different in each repeating unit and each is independently an integer ranging from 0 to 5.

2. The polymer for an optical film of claim 1, wherein in Chemical Formula 1,
R¹ and R² are the same or different in each repeating unit and are each independently CN or —C(═O)OR²⁰⁰, wherein R²⁰⁰ is a C1 to C20 alkyl group, a C6 to C20 aryl group, a C7 to C20 arylalkyl group, or a C7 to C20 alkylaryl group,
R³ is the same or different in each repeating unit and each is independently hydrogen, or a substituted or unsubstituted C1 to C10 alkyl group,
R⁴ is the same or different in each repeating unit and each is independently a halogen, a substituted or unsubstituted C1 to C10 alkoxy group, a substituted or unsubstituted C6 to C15 aryloxy group, a substituted or unsubstituted C2 to C10 ester group (—OC(═O)R²⁰² or —C(═O)OR²⁰³, wherein R²⁰² and R²⁰³ are the same or different and are each independently a C1 to C10 alkyl group), or a carboxyl group, and
n1 is the same or different in each repeating unit and each is independently an integer ranging from 0 to 5, and
wherein, in Chemical Formula 2,
R⁵ to R⁷ are the same or different in each repeating unit and are each independently hydrogen, or a substituted or unsubstituted C1 to C10 alkyl group,
R⁸ is the same or different in each repeating unit and each is independently a halogen, a substituted or unsubstituted C1 to C10 alkoxy group, a substituted or unsubstituted C6 to C15 aryloxy group, a substituted or unsubstituted C2 to C10 ester group (—OC(═O)R²⁰⁶ or —C(═O)OR²⁰⁷, wherein R²⁰⁶ and R²⁰⁷ are the same or different and are each independently a C1 to C10 alkyl group), or a carboxyl group, and
n2 is the same or different in each repeating unit and each is independently an integer ranging from 0 to 5.

3. The polymer for an optical film of claim 1, wherein the repeating unit represented by the Chemical Formula 1 comprises a repeating unit represented by the following Chemical Formulas 3 to 5, or a combination thereof, and the repeating unit represented by the Chemical Formula 2 comprises a repeating unit represented by the following Chemical Formulas 6 to 9, or a combination thereof:

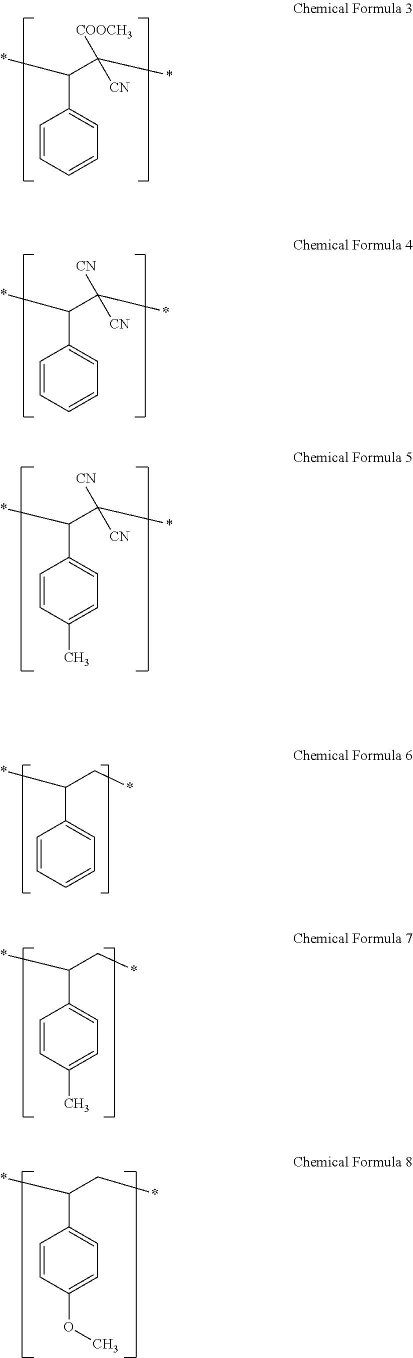

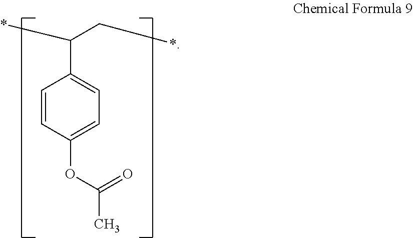

4. The polymer for an optical film of claim 1, wherein the polymer for an optical film comprises the repeating unit A in an amount of greater than about 0 mol % and less than or equal to about 50 mol %, and the repeating unit B in an amount of greater than or equal to about 50 mol % and less than about 100 mol %, based on a total moles of the repeating units included in the polymer for an optical film.

5. The polymer for an optical film of claim 1, wherein the polymer for an optical film has a weight average molecular weight (“Mw”) of about 100,000 grams per mole to about 1,000,000 grams per mole.

6. The polymer for an optical film of claim 1, wherein the polymer for an optical film has a number average molecular weight (“Mn”) of about 50,000 grams per mole to about 500,000 grams per mole.

7. The polymer for an optical film of claim 1, wherein the polymer for an optical film has a polydispersity index of about 1.1 to about 5.0.

8. The polymer for an optical film of claim 1, wherein the polymer for an optical film has a refractive index of about 1.50 to about 1.65.

9. The polymer for an optical film of claim 1, wherein the polymer for an optical film has a glass transition temperature (“T_{g}”) of about 80° C. to about 200° C.

10. A method of preparing a polymer for an optical film, the method comprising:
contacting a monomer represented by the following Chemical Formula 1-1, a monomer represented by the following Chemical Formula 2-1, and a free radical initiator; and
polymerizing the monomers to provide the polymer for the optical film: 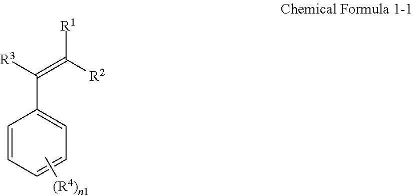
wherein, in Chemical Formula 1-1,
R¹ and R² are the same or different in each monomer and are each independently hydrogen, a substituted or unsubstituted C1 to C10 aliphatic group, —CN, or —C(═O)OR²⁰⁰, wherein R²⁰⁰ is a substituted or unsubstituted C1 to C30 aliphatic group, a substituted or unsubstituted C3 to C30 alicyclic group, a substituted or unsubstituted C6 to C30 aromatic group, or a substituted or unsubstituted C2 to C30 heterocyclic group, wherein at least one of R¹ and R² is —CN or —C(═O)OR²⁰⁰,
R³ is the same or different in each monomer and each is independently hydrogen, a substituted or unsubstituted C1 to C10 aliphatic group, —CN or —C(═O)OR²⁰¹, wherein R²⁰¹ is a substituted or unsubstituted C1 to C30 aliphatic group, a substituted or unsubstituted C3 to C30 alicyclic group, a substituted or unsubstituted C6 to C30 aromatic group, or a substituted or unsubstituted C2 to C30 heterocyclic group,
R⁴ in Chemical Formula 1-1 is the same or different in each monomer and each is independently a halogen, a substituted or unsubstituted C1 to C30 aliphatic group, a substituted or unsubstituted C3 to C30 alicyclic group, a substituted or unsubstituted C6 to C30 aromatic group, a substituted or unsubstituted C2 to C30 heterocyclic group, a substituted or unsubstituted C1 to C30 alkoxy group, a substituted or unsubstituted C6 to C30 aryloxy group, a substituted or unsubstituted C2 to C30 ester group (—OC(═O)R²⁰² or —C(═O)OR²⁰³, wherein R²⁰² and R²⁰³ are the same or different and are each independently a C1 to C10 alkyl group), a substituted or unsubstituted C2 to C30 ketone group, a carboxyl group, a cyano group, or —N(R²⁰⁴)(R²⁰⁵) (wherein R²⁰⁴ and R²⁰⁵ are the same or different and are each independently hydrogen, or a substituted or unsubstituted C1 to C10 aliphatic group), wherein the alicyclic group, aromatic group, and heterocyclic group are present singularly; at least two of the alicyclic group, aromatic group, and heterocyclic group are linked to provide a condensed cyclic group; or at least two of the alicyclic group, aromatic group, and heterocyclic group are linked via a single bond, —O—, —S—, —C(═O)—, —CH(OH)—, —S(═O)₂—, —Si(CH₃)₂—, —(CH₂)ₚ— (wherein 1≦p≦10), —(CF₂)_{q}— (wherein 1≦q≦10), —C(CH₃)₂—, —C(CF₃)₂—, or —C(═O)NH—, and
n1 in Chemical Formula 1-1 is the same or different in each monomer and each is independently an integer ranging from 0 to 5, 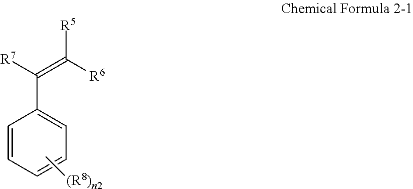
wherein, in Chemical Formula 2-1,
R⁵ to R⁷ are the same or different in each monomer and are each independently hydrogen, or a substituted or unsubstituted C1 to C10 aliphatic group,
R⁸ is the same or different in each monomer and each is independently a halogen, a substituted or unsubstituted C1 to C30 aliphatic group, a substituted or unsubstituted C3 to C30 alicyclic group, a substituted or unsubstituted C6 to C30 aromatic group, a substituted or unsubstituted C2 to C30 heterocyclic group, a substituted or unsubstituted C1 to C30 alkoxy group, a substituted or unsubstituted C6 to C30 aryloxy group, a substituted or unsubstituted C2 to C30 ester group (—OC(═O)R²⁰⁶ or —C(═O)OR²⁰⁷, wherein R²⁰⁶ and R²⁰⁷ are the same or different and are each independently a C1 to C10 alkyl group), a substituted or unsubstituted C2 to C30 ketone group, a carboxyl group, a cyano group, or —N(R²⁰⁸)(R²⁰⁹) (wherein R²⁰⁸ and R²⁰⁹ are the same or different and are each independently hydrogen, or a substituted or unsubstituted C1 to C10 aliphatic group), wherein the alicyclic group, aromatic group, and heterocyclic group are present singularly; at least two of the alicyclic group, aromatic group, and heterocyclic group are linked to provide a condensed cyclic group; or at least two of the alicyclic group, aromatic group, and heterocyclic group are linked via a single bond, —O—, —S—, —C(═O)—, —CH(OH)—, —S(═O)₂—, —Si(CH₃)₂—, —(CH₂)ₚ— (wherein 1≦p≦10), —(CF₂)_{q}— (wherein 1≦q≦10), —C(CH₃)₂—, —C(CF₃)₂—, or —C(═O)NH—, and
n2 in Chemical Formula 2-1 is the same or different in each monomer and each is independently an integer ranging from 0 to 5.

11. The method of claim 10, wherein the free radical initiator comprises a peroxide-containing initiator, an azo-containing initiator, or a combination thereof.

12. The method of claim 11, wherein the peroxide-containing initiator comprises benzoyl peroxide, t-butylperoxy-2-ethyl hexanoate, dicumyl peroxide, t-butyl peroxide, 1,1-di(t-butylperoxy)cyclohexane, dibenzoyl peroxide, 2-butanone peroxide, t-butyl perbenzoate, 2,5-bis(t-butylperoxy)-2,5-dimethylhexane, bis(t-butylperoxyisopropyl)benzene, t-butyl hydroperoxide, or a combination thereof.

13. An optical film comprising the polymer for an optical film according to claim 1.

14. The optical film of claim 13, wherein the optical film has an in-plane phase-difference value (“Rₑ”) ranging from about 0 nanometers to about 500 nanometers at a wavelength of about 550 nanometers.

15. The optical film of claim 13, wherein the optical film has a thickness direction phase-difference value (“Rₜₕ”) ranging from about 0 nanometers to about −1000 nanometers at a wavelength of about 550 nanometers.

16. The optical film of claim 13, wherein the optical film has a short wavelength dispersion of an in-plane phase-difference value (“Rₑ”) (450 nanometers/550 nanometers) ranging from about 1.00 to about 1.20, and a long wavelength dispersion of an in-plane phase-difference value (“Rₑ”) (650 nanometers/550 nanometers) ranging from about 0.90 to about 1.00.

17. The optical film of claim 13, wherein the optical film has an average light transmittance of greater than or equal to about 80% at a wavelength range of about 380 nanometers to about 780 nanometers.

18. The optical film of claim 13, wherein the optical film has a haze of less than or equal to about 5%.

19. The optical film of claim 13, wherein the optical film has a glass transition temperature (“T_{g}”) of about 80° C. to about 200° C.

20. A display device comprising the optical film according to claim 13.
